(19) United States
(12) Patent Application Publication
(10) Pub. No.: US 2007/0149195 A1
(43) Pub. Date: Jun. 28, 2007

(54) Apparatus and method for providing seamless handover

(75) Inventors: Yun-Ju Choe, Uiwang-si (KR); Young-Keun Kim, Incheon (KR); Soo-Hong Park, Yongin-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/601,619

(22) Filed: Nov. 20, 2006

(30) Foreign Application Priority Data
Dec. 27, 2005 (KR) 2005-130784

(51) Int. Cl. H04Q 7/20

(52) U.S. Cl. 455/436

(57) ABSTRACT

A method and apparatus to provide a handover includes an input unit which receives information on a handover mode and a handover priority corresponding to a plurality of wireless networks, a signal-intensity-measuring unit which measures a signal intensity of a wireless network where a current communication is performed out of the plurality of wireless networks, and a control unit which performs a mobile node handover to a predetermined wireless network according to the information about a handover mode and a handover priority, if the measured signal intensity is less than a threshold intensity value.

### CROSS-REFERENCE TO RELATED APPLICATION

This application claims the benefit of Korean Application No. 2005-130784, filed Dec. 27, 2006, in the Korean Intellectual Property Office, the disclosure of which is incorporated herein by reference.

### BACKGROUND OF THE INVENTION

1. Field of the Invention

Aspects of the present invention relate to a mobile apparatus, and more particularly, to an apparatus and method to provide a selective handover in a wireless network.

2. Description of the Related Art

Recently, with the advancements made in wireless network technologies, the use of mobile wireless computing applications has been increasing, and research on handover technologies is currently being conducted on a wide scale. The term “handover” refers to technology which maintains a communication service between a mobile node and networks, even when the mobile node is moved to a homogeneous or heterogeneous network.

When performing a conventional handover, a user of the mobile node does not have access to certain types of information about new wireless networks to which the user moves into. For example, if a user moves to a CDMA network within a wireless local area network (WLAN), the user's mobile node automatically connects to the code division multiple access (CDMA) network. In other words, when conventional handovers are performed, a user begins using a new service without having access to information regarding the network.

Furthermore, in conventional handovers, all network interfaces in a mobile node are activated in order to find a wireless network able to perform a handover. This activation of each network interface unnecessarily increases the power consumption of the mobile node.

Several inventions (e.g., Korean Unexamined Patent No. 2004-32803: System and Method for Integrating WLAN and G3) have been suggested to try and fix the above-mentioned problems associated with conventional handovers. However, these inventions have not been completely effective in solving these problems, and therefore, the above-described problems still remain to be solved.

Thus, an apparatus and method capable of performing a handover according to a user's selection, as well as minimizing power consumption of a mobile node when performing a handover, is needed.

### SUMMARY OF THE INVENTION

In view of the above, an aspect of the present invention provides information on a to-be-connected network to a user when a mobile node handover is performed in a wireless network environment, in which a handover is performed according to a user's selection, and the power consumption of a mobile node is reduced.

Additional aspects and/or advantages of the invention will be set forth in part in the description which follows and, in part, will be obvious from the description, or may be learned by practice of the invention.

According to an aspect of the present invention, a mobile device which can perform a handover includes an input unit which receives information about a handover mode and a handover priority corresponding to a plurality of wireless networks, a signal-intensity-measuring unit which measures a signal intensity of a wireless network to which the device is currently communication out of the plurality of wireless networks, and a control unit which performs a mobile node handover to a predetermined wireless network according to the information on a handover mode and the information on a handover priority, if the measured signal intensity is less than a threshold intensity value.

According to another aspect of the present invention, a method of performing a handover includes receiving information about a handover mode and a handover priority corresponding to a plurality of wireless networks, measuring a signal intensity of a wireless network to which a communication is currently being performed out of the plurality of wireless networks, and performing a mobile node handover to a predetermined wireless network according to the information about the handover mode and the handover priority, if the measured signal intensity is less than a threshold intensity value.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 illustrates a wireless network environment which a handover-providing apparatus according to an embodiment of the present invention functions within;

FIG. 2 is a block diagram which depicts a handover-providing apparatus according to an embodiment of the present invention;

FIGS. 3A through 3E illustrate a screen included with the handover-providing apparatus shown in FIG. 2;

FIG. 4 illustrates a network priority table according to an embodiment of the present invention;

FIG. 5 is a flowchart which depicts a process of operating the handover-providing apparatus according to another embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

Advantages and features of the present invention and methods of accomplishing the same may be understood more readily by reference to the following detailed description of the embodiments and the accompanying drawings. The present invention may, however, be embodied in many different forms and should not be construed as being limited to the embodiments set forth herein. Rather, these embodiments are provided so that this disclosure will be thorough and complete and will fully convey the concept of the present invention to those skilled in the art, and the present invention will only be defined by the appended claims. Like reference numerals refer to like elements throughout the specification.

Aspects of the present invention are described hereinafter with reference to flowchart illustrations of user interfaces, methods, and computer program products according to embodiments of the present invention. It is understood that each block of the flowchart illustrations, and combinations of blocks in the flowchart illustrations, may be implemented by computer program instructions. These computer program instructions may be provided to a processor of a general purpose computer, special purpose computer, or other programmable data processing apparatus in order to produce a machine, such that the instructions, which execute via the processor of the computer or other programmable data processing apparatus, may be used to implement the functions specified in the flowchart block or blocks. These computer program instructions may also be stored in a computer usable or computer-readable memory which may direct a computer or other programmable data processing apparatus to function in a particular manner, such that the instructions stored in the computer usable or computer-readable memory produce an article of manufacture, including, but not limited to, instructions which implement a function specified in the flowchart block or blocks. The computer program instructions may also be loaded into a computer or other programmable data processing apparatus to perform a series of operations into the computer or other programmable apparatus in order to produce a computer implemented process, so that the instructions which are executed in the computer or other programmable apparatus provide operations to implement the functions specified in the flowchart block or blocks.

Furthermore, each block of the flowchart illustrations may represent a module, segment, or portion of code, which includes one or more executable instructions to implement the specified logical function(s). It should also be noted that in some alternative implementations, the functions noted in the blocks may occur out of order. For example, two blocks shown in succession may in fact be executed simultaneously or nearly simultaneously. The blocks may also be executed out of order and/or in the reverse order of the order illustrated in the block diagrams, depending upon which function a user is executing.

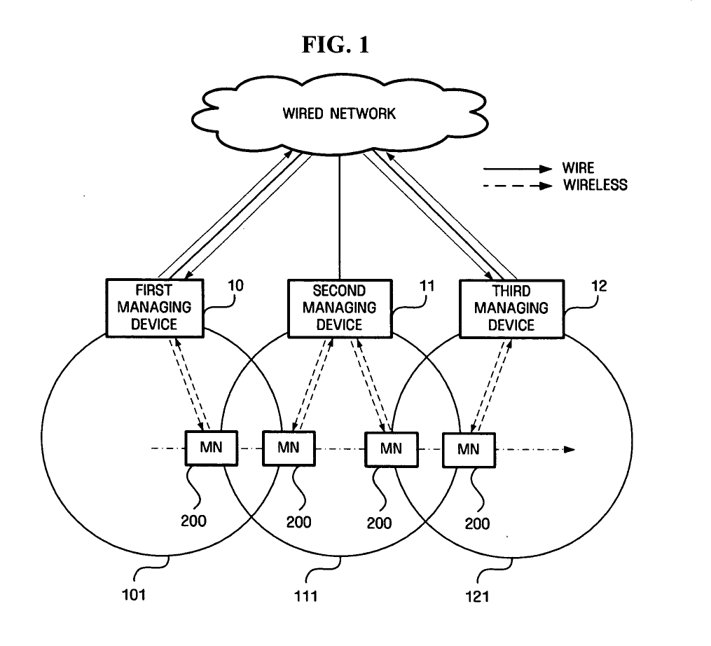

FIG. 1 illustrates a wireless network environment which the handover-providing apparatus 200 according to an embodiment of the present invention functions within. The illustrated wireless network environment shown in FIG. 1 includes a handover-providing apparatus 200, a first managing device 10, a second managing device 11, and a third managing device 12. It is understood that the illustrated wireless network may have more or less than three managing devices.

The handover-providing apparatus 200 is a mobile node (MN) device which changes a point of attachment from a single network to another network. When moving from a home link to an external link, the handover-providing apparatus 200 maintains communications with the wireless network environment shown in FIG. 1 by receiving an Internet protocol (IP) address via a new link. Also, the handover-providing apparatus 200 includes at least an auto-handover mode and a manual-handover mode.

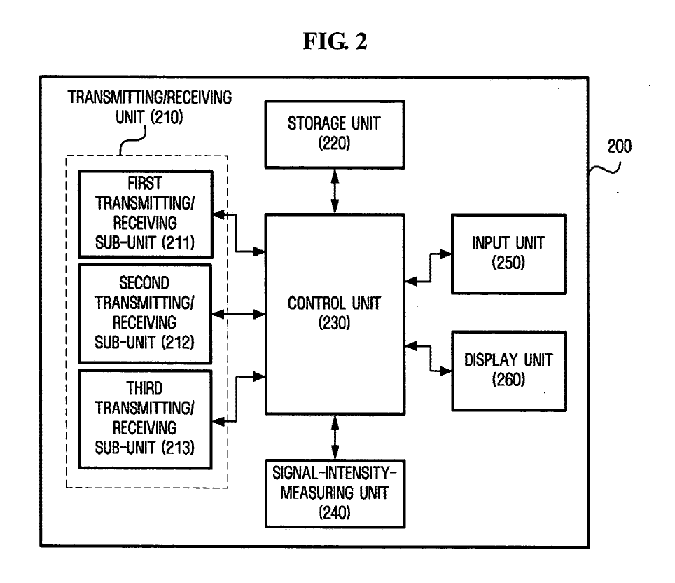

The auto-handover mode refers to performing a handover according to information set in advance, without notifying a user about a network capable of performing the handover. The manual-handover mode refers to performing the handover to a network selected by a user by showing information on a network where the handover can be performed to a user via a display unit (see reference number 260 of FIG. 2). The handover-providing apparatus 200 may be embodied as a mobile phone, a laptop computer, a personal digital assistant (PDA), or a voice-over-Internet protocol (VoIP) telephone, but is not limited thereto. It is understood that the handover-providing apparatus 200 may be embodied as any type of mobile technology capable of communicating with a wireless network. The handover-providing apparatus 200 will be described in detail with reference to FIG. 2.

The first managing device 10, the second managing device 11, and the third managing device 12 respectively correspond to the first network 101, the second network 111, and the third network 121. The first managing device 10, the second managing device 11, and the third managing device 12 are each capable of connecting the handover-providing apparatus 200 to a wired network, such as the Internet, by connecting the handover-providing apparatus 200 to an appropriate wireless network corresponding to the respective managing device. In order to connect the handover-providing apparatus 200 to the appropriate network, each device periodically transmits information to the handover-providing apparatus 200 pertaining to the network respectively managed by each device.

In FIG. 1, a first network 101, a second network 111, and a third network 121 respectively managed by the first managing device 10, the second managing device 11, and the third managing device 12 may, for example, be heterogeneous (different types of) networks. For example, the first network 101, the second network 111, and the third network 121 may respectively be a basic service set (BSS), a code division multiple access (CDMA) network, and a wireless broadband Internet (WiBro). It is understood that the first, second and third networks, 101, 111, and 121 respectively, do not have to be heterogeneous networks.

The handover-providing apparatus 200 according to an embodiment of the present invention will be described with reference to FIGS. 2 through 4.

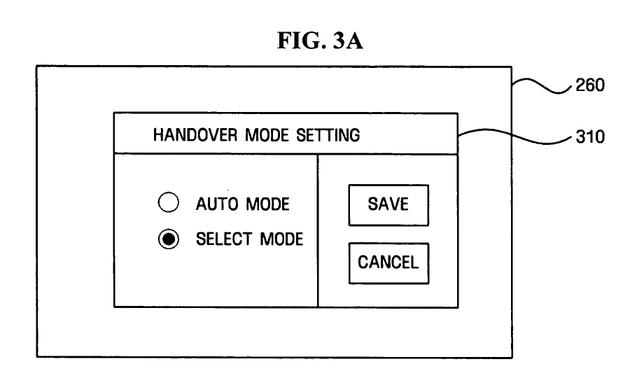

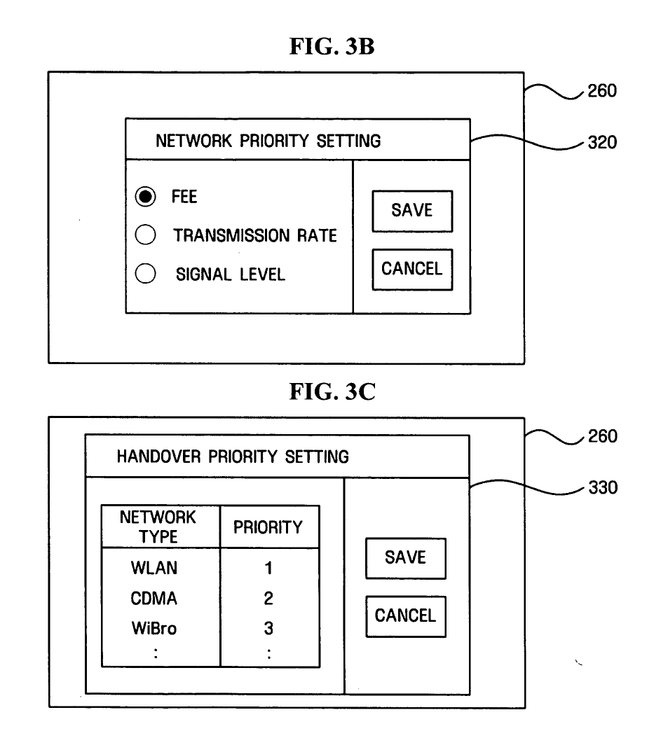

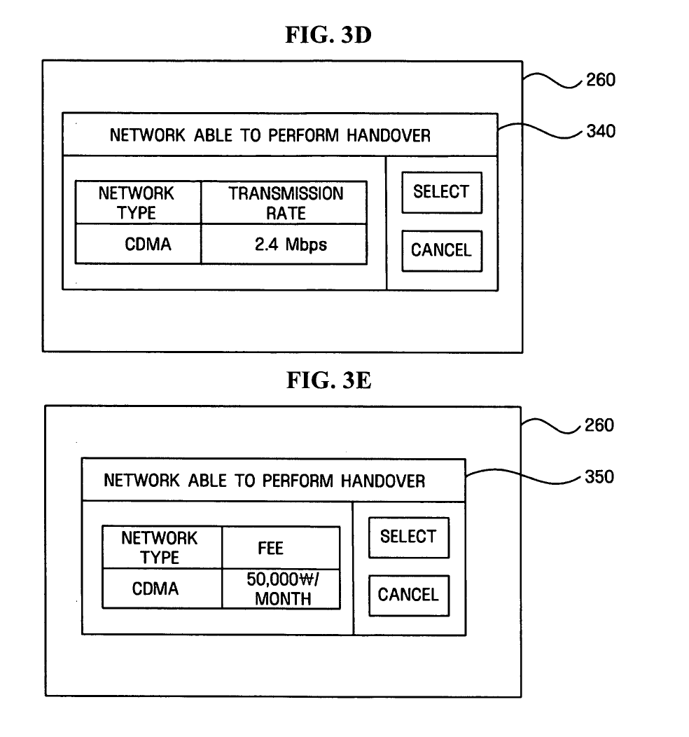

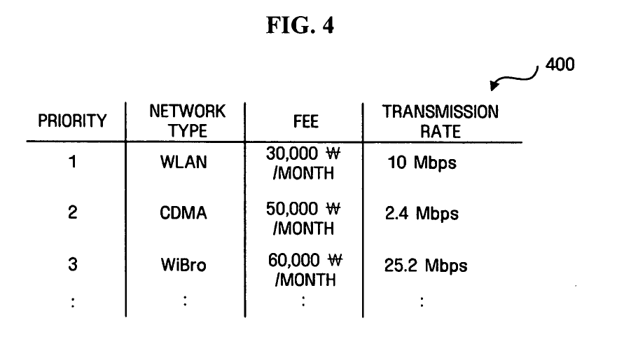

FIG. 2 is a block diagram which depicts a handover-providing apparatus according to an embodiment of the present invention. FIGS. 3A through 3E illustrate a screen included with the handover-providing apparatus 200 shown in FIG. 2. FIG. 4 illustrates a network priority table according to an embodiment of the present invention.

The handover-providing apparatus 200 illustrated in FIG. 2 includes a plurality of transmitting/receiving units 210, an input unit 250, a display unit 260, a signal-intensity-measuring unit 240, a storage unit 220, and a control unit 230. It is understood that the handover-providing apparatus 200 may also include other components than the components illustrated in FIG. 2.

The transmitting/receiving unit 210 may be a single unit which receives data, such as data pertaining to a signal intensity, fee information, and/or service information. A managing device located in a predetermined network, such as the first managing device 10, transmits data to the transmitting/receiving unit 210. Conversely, the transmitting/receiving unit 210 transmits data about the handover-providing apparatus 200 to the managing device. Alternatively, the transmitting/receiving unit 210 may include a plurality of transmitting/receiving sub-units which provide different network interfaces. For example, the transmitting/receiving unit 210 may include a first transmitting/receiving sub-unit 211 which includes a wireless network interface, a second transmitting/receiving sub-unit 212 which includes a CDMA communication interface, and a third transmitting/receiving sub-unit 213 which includes a portable Internet communication interface. Hereinafter, as an example, the transmitting/receiving unit 210 includes first, second, and third transmitting/receiving sub-units which respectively include a wireless network interface, a CDMA communication interface, and a portable Internet communication interface. It is understood that the transmitting/receiving unit 210 may be constructed differently than the foregoing example.

The input unit 250 receives an input value from a user. For example, the input unit 250 receives an input value to set a handover mode, a handover priority, and a network preference. It is understood that the input unit 250 may receive other types of input values from a user as well.

In order to display an instruction or a result of an instruction inputted via the input unit 250, the display unit 260 displays a user interface which enables a user to input settings, such as, for example, a handover mode, a network preference, and a handover priority. For example, the display unit 260 displays a handover-mode-setting user interface 310 which enables a user to set a handover mode, such as the automatic mode and the select mode illustrated in FIG. 3A. In another example, the display unit 260 displays a priority-setting user interface 330 which enables a user to set a handover priority, such as a WLAN network, a CDMA network, and a WiBro network, as illustrated in FIG. 3C. The display unit 260 may be separated from the input unit 250, such as a screen and optical mouse combination. Alternatively, the display unit 260 may be combined with the input unit 250, such as a touch screen or a touch pad.

The storage unit 220 stores information about a handover mode, a handover priority, and a user's network priority set by a user. As an example, the handover priority and network priority information may be stored as a table, such as the table illustrated in FIG. 4. The storage unit 220 stores a signal-intensity-checking period and a threshold intensity value of the signal intensity. The storage unit 220 may be, but is not limited to being, a nonvolatile memory device, such as a cache, read-only memory (ROM), programmable ROM (PROM), erasable PROM (EPROM), electronically erasable EPROM (EEPROM), or a flash memory, a volatile memory device such as random access memory (RAM), or a storage medium such as hard disk drive (HDD). It is understood that other types of memories may also be used as the storage unit 220.

The signal-intensity-measuring unit 240 measures the signal intensity of the network which the handover-providing apparatus 200 is connected to at a given time, and transmits the measured signal intensity to a control unit 230. In FIG. 1, where the handover-providing apparatus 200 is located in the first network 101, then the signal-intensity-measuring unit 240 measures the signal intensity in the first network 101 and transmits the intensity to the control unit 230 described below.

The control unit 230 analyzes signal intensity information provided by the signal-intensity-measuring unit 240 in real-time, and performs a handover of the handover-providing apparatus 200 depending on the result of the analysis. More specifically, the control unit 230 determines whether signal intensity has been maintained at an intensity less than a threshold intensity value for a predetermined time.

If the signal intensity has not been maintained at an intensity less than the threshold intensity value for the predetermined time, the control unit 230 does not perform a handover. For example, if the three-second analysis of the signal intensity provided by the signal-intensity-measuring unit 240 shows that the signal intensity is less than the threshold intensity value for only two seconds, the control unit 230 does not perform a handover. It is understood that the predetermined time may be longer or shorter than three seconds.

If the signal intensity has been maintained at an intensity less than the threshold intensity value for the predetermined time, the control unit 230 performs a handover. For example, if the three-second analysis of the signal intensity provided by the signal-intensity-measuring unit 240 shows that the signal intensity is less than the threshold intensity value for four seconds, the control unit 230 performs a handover.

If the signal intensity has been maintained at an intensity less than the threshold intensity value for the predetermined time, the control unit 230 performs a handover according to handover mode information inputted by a user. If the handover mode is set as an auto-handover mode, the control unit 230 successively activates the corresponding transmitting/receiving unit 210 with reference to a network priority table 400 stored in the storage unit 220. More specifically, a user may input the priority of networks to be connected to, such as, for example, a WLAN network interface, a CDMA network interface, and a WiBro network interface, as illustrated in FIG. 4. In this example, when the transmitting/receiving unit 210 sends and receives data via the current wireless network interface, i.e., the first transmitting/receiving sub-unit 211, the control unit 230 activates the CDMA network interface, i.e., the second transmitting/receiving sub-unit 212, thereby enabling the transmitting/receiving unit 210 to receive information pertaining to the second network 111 via the second transmitting/receiving sub-unit 212. The signal-intensity-measuring unit 240 measures the signal intensity in the second network 111, and transmits the measured intensity to the control unit 230.

Next, the control unit 230 performs a handover to the second network 111 according to the result of an analysis. During this analysis, the control unit 230 determines whether the signal intensity in the second network 111 has been maintained at an intensity less than a threshold intensity value for a predetermined time.

If the signal intensity in the second network 111 has been maintained at an intensity less than a threshold intensity value for a predetermined time, the control unit 230 activates the third transmitting/receiving sub-unit 213 corresponding to the next network on the priority table, i.e., the WiBro network interface, with reference to the network priority table 400. Depending on the analysis of the signal intensity in the third network 121, the control unit 230 performs a handover.

If the signal intensity has not been maintained at an intensity less than a threshold intensity value for a predetermined time, the control unit 230 determines whether a signal intensity in the second network 111 is higher than the signal intensity in the first network 101. If the signal intensity in the second network 111 is higher than the signal intensity in the first network 101, the control unit 230 performs a handover to the second network 111. However, if the signal intensity in the second network 111 is lower than the signal intensity in the first network 101, the control unit 230 activates the third transmitting/receiving unit 213 on the priority table, i.e., the WiBro network interface, with reference to the network priority table 400. Depending on the analysis of the signal intensity in the third network 121, the control unit 230 performs a handover to the third network 121.

If the handover mode is set to a manual-handover mode, the control unit 230 displays handover lists 340 and 350 via the display unit 260. The handover list refers to a list which includes information on networks capable of performing a handover, such as information pertaining to signal intensity, a transmission rate, and the fee of the networks capable of performing the handover. It is understood that information other than information pertaining to signal intensity, transmission rates, and network fees may be displayed in the handover lists 340 and 350.

When the handover lists 340 and 350 are displayed via the display unit 260, the most-preferred network information is displayed out of all the information on the corresponding networks. More specifically, a user can set the preferred network in advance. When the handover lists 340 and 350 are displayed via the display unit 260, the control unit 230 preferentially displays the preferred network information. For example, if a user prioritizes the transmission rate as the highest priority, the transmission rate information is preferentially displayed in the handover list 340, as illustrated in FIG. 3D. As another example, if a user prioritizes the network fees as the highest priority, the fee information is preferentially displayed in the handover list 340, as illustrated in FIG. 3E.

When the handover lists 340 and 350 are displayed via the display unit 260, a user can choose to perform a handover to the corresponding network by inputting a select instruction into the input unit 250. If a user inputs a command to perform a handover when the handover list 340 is displayed, as illustrated in FIG. 3D, the control unit 230 performs a handover to the second network by performing a process or series of processes, such as setting and/or authenticating the second managing device 11 via the second transmitting/receiving sub-unit 212.

A handover-providing method according to an embodiment of the present invention will be described with reference to FIGS. 2 through 5.

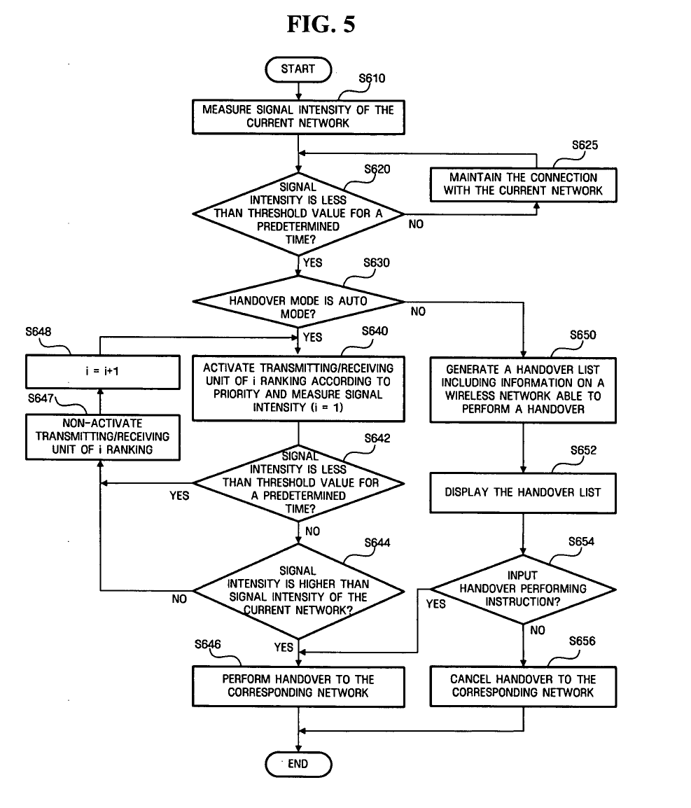

FIG. 5 is a flowchart which depicts a process of operating a handover-providing apparatus 200 according to an embodiment of the present invention.

The signal-intensity-measuring unit 240 measures the signal intensity of the network which the handover-providing apparatus 200 is connected to at a given time S610. For example, if the handover-providing apparatus 200 is currently connected to the first network 101, the signal-level-measuring unit 240 measures a signal intensity received via the first transmitting/receiving sub-unit 211, i.e., a signal intensity of the first network, and then transmits the measured signal intensity to the control unit 230.

The control unit 230 then analyzes the signal intensity transmitted by the signal-intensity-measuring unit 240. More specifically, the control unit 230 analyzes the signal intensity for a predetermined time in order to determine whether the measured signal intensity has been maintained at an intensity less than a threshold intensity value for the time S620. For example, the control unit 230 determines whether the signal intensity has been maintained at an intensity less than a threshold intensity value for three seconds. It is understood that the predetermined time may be longer or shorter than three seconds.

If the signal intensity has not been maintained at an intensity less than a threshold intensity value for a predetermined time, such as, for example, three seconds (“NO” in S625), the control unit 230 does not perform a handover. In this case, the control unit 230 maintains the connection between the handover-providing apparatus 200 and the currently connected network S625. Thus, for example, if the signal intensity measured in a predetermined three-second time frame is less than a threshold intensity value for only one second, and the signal intensity is measured above the threshold intensity value for the remaining two seconds, the control unit 230 does not perform a handover. In this case, the connection with the first network 101 is maintained.

If the signal intensity has been maintained at an intensity less than a threshold intensity value for at least the predetermined time, such as, for example, three seconds (“YES” in S625), the control unit 230 determines that the quality of the connection to the currently-connected wireless network is poor. As a result, the control unit 230 performs a handover to a predetermined network according to a preset handover mode type S630.

More specifically, if the handover mode is set to an auto-handover mode (“YES” in S630), the control unit 230 successively activates the corresponding transmitting/receiving unit 210, with reference to a network priority table 400 stored in the storage unit 220 S640. For example, when the handover-providing apparatus 200 is connected to the first network 101, if a network priority set by a user is prioritized in order of a WLAN network interface, a CDMA network interface, and a WiBro network interface as illustrated in FIG. 4, the control unit 230 activates the second transmitting/receiving sub-unit 212, which displays the CDMA network interface.

When the control unit 230 activates the second transmitting/receiving sub-unit 212, information on the second network 111, which is transmitted by the second managing device 11, is received via the second transmitting/receiving sub-unit 212. The signal-intensity-measuring unit 240 measures the signal intensity of the information received via the second transmitting/receiving sub-unit 212, and transmits the measured intensity to the control unit 230.

The control unit 230 determines whether to perform a handover to the second network 111 by analyzing the signal intensity transmitted by the signal-intensity-measuring unit 240. More specifically, the control unit 230 determines whether the signal intensity in the second network 111 is maintained at an intensity less than a threshold intensity value for a predetermined time S642.

If the control unit determines that signal intensity in the second network 111 is maintained at less than a threshold intensity value for a preset time (“YES” in S642), the control unit 230 does not activate the second transmitting/receiving sub-unit 212. Instead, the control unit 230 activates the third transmitting/receiving sub-unit 213, which displays the third network interface, for example, the WiBro network interface, on the priority table, with reference to the network priority table 400. By repeating operations S640 through S644, the control unit 230 performs a handover to the third network 121, depending on the analysis of the signal intensity in the third network 121.

In the case where the control unit 230 determines that the signal intensity of the recently analyzed network is not less than a threshold intensity value for a predetermined time S642, the control unit 230 then determines the relative intensity between the currently-connected network and the recently analyzed network. For example, when the currently-connected network is the first network 101, if the signal intensity of the recently analyzed second network 111 is not maintained at an intensity less than a threshold intensity value for a predetermined time (“NO” in S642), the control unit 230 determines whether the signal intensity in the second network 111 is higher than the signal intensity in the first network 101 S644.

If the signal intensity in the second network 111 is higher than the signal intensity in the first network 101 (“YES” in S644), the control unit 230 performs a handover to the second network 111 S646. During this handover, the control unit 230 exchanges data with the second managing device 11 in order to connect the handover-providing apparatus to the second network 111 through a process or series of processes, such as, for example a setting process and/or an authentication process. When the control unit 230 completes the handover to the second network 111, the control unit 230 deactivates the first transmitting/receiving sub-unit 211.

If the control unit 230 determines that the signal intensity in the second network 111 is lower than the signal intensity in the first network 101 (“NO” in S644), the control unit 230 deactivates the second transmitting/receiving sub-unit 212 S647. The control unit 230 then activates the third transmitting/receiving sub-unit 213 which displays the user interface corresponding to the next network on the network priority table 400, such as the WiBro network interface S640. By repeating operations S642 through S648, the control unit 230 performs a handover to the third network 121.

If a handover mode is set as a manual-handover mode (“NO” in S630), the control unit 230 displays handover lists 340 and 350 via the display unit 260. Preferably, the handover lists 340 and 350 are composed according to the network priority stored in the storage unit 220. If, for example, the transmission rate is given the highest priority, the control unit 230 preferentially displays the transmission rate information in the handover list 340, as illustrated in FIG. 3D. If, for example, fee information is given the highest priority, the control unit 230 preferentially displays the fee information in the handover list 340, as illustrated in FIG. 3E.

After the handover lists 340 and 350 are displayed, the control unit 230 performs a handover to the corresponding network according to a value inputted via the input unit 250. More specifically, the control unit 230 determines whether a handover-performing instruction has been inputted via the input unit 250 S654. If the control unit 230 determines that a handover-performing instruction has been inputted (YES in S654), the control unit 230 performs a handover to the corresponding network S646. If a user inputs a command to perform a handover when the handover list 350 is displayed, as illustrated in FIG. 3E, the control unit 230 activates the second transmitting/receiving sub-unit 212 which supports the second network interface, for example, the CDMA network interface, and performs a handover to the second network 111 by performing a process or series of process, such as setting and/or authenticating the second managing device 11 via the second transmitting/receiving sub-unit 212.

If a cancel instruction is inputted when the handover list 350 for the second network 111 is displayed, as illustrated in FIG. 3E, the control unit 230 cancels the handover to the second network S656.

As described above, the apparatus and method to provide a handover according to aspects of the present invention produce various advantages.

First, since information on a network where a handover may be performed is provided to a user, a user can actively select whether to perform a handover.

Second, a network interface is activated according to a preset priority when a handover is performed, thereby reducing power consumption.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A device, comprising:
an input unit which receives information about a handover mode and a handover priority corresponding to a plurality of wireless networks;
a signal-intensity-measuring unit which measures a signal intensity of a wireless network to which the mobile device is currently communicating out of the plurality of wireless networks; and,
a control unit which performs a handover to a predetermined wireless network according to the information about the handover mode and the handover priority, if the measured signal intensity is less than a threshold intensity value.

2. The device of claim 1, wherein the control unit performs the handover to the predetermined wireless network if the measured signal intensity has been maintained at an intensity less than the threshold intensity value for a predetermined time.

3. The device of claim 2, wherein the predetermined time is three seconds.

4. The device of claim 1, further comprising a plurality of transmitting/receiving sub-units which respectively provide communication interfaces corresponding to the plurality of wireless networks.

5. The device of claim 4, wherein the control unit successively activates the transmitting/receiving sub-units corresponding to the inputted handover priority information, if the handover mode is set to an auto-handover mode, to automatically connect the device to a network which maintains a signal intensity greater than the threshold intensity value for a predetermined time.

6. The device of claim 5, wherein the predetermined time is three seconds.

7. The device of claim 1, further comprising a display unit which displays information about a wireless network able to perform the handover, if the handover mode is set to a manual-handover mode, to enable a user to manually connect the device to the wireless network able to perform the handover.

8. The device of claim 7, wherein the predetermined time is three seconds.

9. The device of claim 7, wherein the displayed information is at least one of signal intensity information, transmission rate information, and/or fee information about the wireless network able to perform the handover.

10. The device of claim 7, wherein the control unit performs the handover to the wireless network able to perform the handover if an input value to perform the handover is inputted to the input unit.

11. The device of claim 1, wherein the input unit, signal-intensity-measuring unit and control unit are embodied in a mobile phone, a laptop computer, a personal digital assistant (PDA), or a voice-over-Internet protocol (VoIP) telephone.

12. The device of claim 1, wherein the plurality of wireless networks comprises at least two of a basic service set (BSS), a CDMA (CDMA) network, and a wireless broadband Internet (WiBro).

13. A method of performing a handover, the method comprising:
receiving information about a handover mode and a handover priority corresponding to a plurality of wireless networks;
measuring a signal intensity of a wireless network to which a communication is currently being performed out of the plurality of wireless networks; and,
performing the handover to a predetermined wireless network out of the plurality of networks according to the handover mode information and the handover priority information, if the measured signal intensity is less than a threshold intensity value.

14. The method of claim 13, wherein the performing of the handover comprises performing the handover if the measured signal intensity has been maintained at an intensity less than the threshold intensity value for a predetermined time.

15. The method of claim 14, wherein the predetermined time is three seconds.

16. The method of claim 13, wherein the performing of the handover comprises successively activating transmitting/receiving sub-units corresponding to the handover priority information, if the handover mode is set to an auto-handover mode.

17. The method of claim 16, wherein the predetermined time is three seconds.

18. The method of claim 14, wherein the performing of the handover further comprises displaying information about the predetermined wireless network out of the plurality of wireless networks able to perform the handover, if the handover mode is set to a manual-handover mode.

19. The method of claim 18, wherein the displayed information is at least one of signal intensity information, transmission rate information, and/or fee information about the predetermined wireless network able to perform the handover.

20. The method of claim 18, wherein the displaying of the information comprises performing the handover to the predetermined wireless network able to perform the handover, if an input value to perform the handover is inputted to an input unit.

21. The method of claim 13, wherein the receiving of the information, the measuring of the signal intensity, and the performing of the handover all occur in a mobile phone, a laptop computer, a personal digital assistant (PDA), or a voice-over-Internet protocol (VoIP) telephone.

22. A device, comprising:
a signal-intensity-measuring unit to measure a signal intensity of each wireless network among a plurality of wireless networks;
a plurality of transmitting/receiving sub-units which respectively provide communication interfaces corresponding to the plurality of wireless networks; and
a control unit enabling a user to input preferences of one or more of the wireless networks among the plurality of wireless networks to selectively connect the mobile device to one of the wireless networks among the plurality of wireless networks.

23. The device of claim 22, wherein the preferences comprise at least one of signal intensity information, transmission rate information, and/or fee information.

24. The device of claim 22, further comprising a display unit which displays the preferences, if a handover mode is set to a manual-handover mode, to enable a user to manually connect the device to a wireless network according to the preferences.

25. The device of claim 22, wherein the control unit performs a handover to a predetermined wireless network if the measured signal intensity has been maintained at an intensity less than a threshold intensity value for a predetermined time.

26. The device of claim 25, wherein the predetermined time is three seconds.

27. The device of claim 22, wherein the control unit successively activates the transmitting/receiving sub-units according to the preferences, if a handover mode is set to an auto-handover mode, to automatically connect the device to a wireless network according to the preferences.

28. The device of claim 27, wherein the predetermined time is three seconds.

29. The device of claim 22, wherein the signal-intensity-measuring unit, the plurality of transmitting/receiving sub-units, and the control unit are embodied in a mobile phone, a laptop computer, a personal digital assistant (PDA), or a voice-over-Internet protocol (VoIP) telephone.

30. A device, comprising:
a signal-intensity-measuring unit which measures a signal intensity of a wireless network to which the mobile device is currently communicating out of a plurality of wireless networks;
a plurality of transmitting/receiving sub-units which respectively provide communication interfaces corresponding to the plurality of wireless networks; and
a control unit which activates the transmitting/receiving sub-units to perform a handover between the wireless network to which the mobile device is currently communicating and another wireless network in the plurality of wireless networks, wherein the transmitting/receiving sub-units are not activated simultaneously.

31. The device of claim 30, wherein the control unit successively activates the transmitting/receiving sub-units according to a priority table.

32. The device of claim 31, wherein the signal-intensity-measuring unit, the plurality of transmitting/receiving sub-units, and the control unit are embodied in a mobile phone, a laptop computer, a personal digital assistant (PDA), or a voice-over-Internet protocol (VoIP) telephone.
